(19) United States
(12) Patent Application Publication
(10) Pub. No.: US 2024/0159251 A1
(43) Pub. Date: May 16, 2024

(54) FUEL CELL EJECTOR

(71) Applicant: FORD GLOBAL TECHNOLOGIES, LLC, Dearborn, MI (US)

(72) Inventor: Xiaogang Zhang, Novi, MI (US)

(21) Appl. No.: 17/988,554

(22) Filed: Nov. 16, 2022

(51) Int. Cl. F04F 5/46; F04F 5/20; H01M 8/04746

(52) U.S. Cl. CPC F04F 5/463; F04F 5/20; H01M 8/04753

(57) ABSTRACT

An ejector housing defines a suction chamber, a mixing chamber, and a diffuser nozzle. The diffuser nozzle defines a restrictive orifice, and a diffuser outlet. A first port supplies an entrained fluid to the mixing chamber. First and second motive fluid nozzles include a first valve and a second valve selectively supply first and second portions of the motive fluid to the mixing chamber through first and second motive fluid nozzle outlets. A controller selectively opens and closes the first valve and the second valve to controller the level of fluid flow through the first port.

### TECHNICAL FIELD

This disclosure relates to a multistage ejector apparatus for fuel cells.

### BACKGROUND

Fuel cells are electrochemical cells that convert the chemical energy of a fuel (e. g. hydrogen) and an oxidizing agent (e. g. oxygen) into electricity (e. g. in a pair of redox reactions). Fuel cells are filled with an electrolyte fluid through which hydrogen and oxygen are combined. Oxidation occurs at an anode and reduction occurs at a cathode. The oxidation and reduction reactions are linked and produce electrons that flow through the external circuit.

Fuel cells can include an ejector that uses a high-pressure motive fuel stream to induce flow and boost the pressure of a low pressure secondary fluid. The ejector includes a nozzle for motive flow, a suction port, a suction chamber, a mixing chamber, and a diffuser. Vacuum is generated at the mixing chamber that depends on the back pressure difference between the motive fluid inlet and the mixture outlet. Ejectors having higher entrained fluid flow rates than existing ejector designs are desired.

This disclosure is directed to solving the above problems and other problems as summarized below.

### SUMMARY

According to a first aspect of this disclosure, an apparatus is disclosed that comprises an ejector housing defining a suction chamber, a mixing chamber, and a diffuser nozzle that defines a restrictive orifice, and a diffuser outlet. A first port supplies an entrained fluid to the mixing chamber. A first motive fluid nozzle supplies a first portion of the motive fluid to the mixing chamber through a first motive fluid nozzle outlet that extends into the mixing chamber to a first location spaced a distance “D” from the restrictive orifice. A second motive fluid nozzle supplies a second portion of the motive fluid to the mixing chamber through a second motive fluid nozzle outlet that extends into the mixing chamber to a second location spaced a distance “d” from the restrictive orifice, wherein the distance d is less than the distance D. The first portion and second portion of the motive fluid generate vacuum that draws the entrained fluid through the first port into the mixing chamber.

According to a second aspect of this disclosure, an apparatus that comprises an ejector housing defining a suction chamber, a mixing chamber, and a diffuser nozzle that defines a restrictive orifice, and a diffuser outlet. A first port supplies an entrained fluid to the mixing chamber. A first motive fluid nozzle supplies a first portion of the motive fluid to the mixing chamber through a first motive fluid nozzle outlet that extends into the mixing chamber. A second motive fluid nozzle supplies a second portion of the motive fluid to the mixing chamber through a second motive fluid nozzle outlet that extends into the mixing chamber, wherein the first motive fluid nozzle is larger than the second motive fluid nozzle, and wherein the second motive fluid nozzle is disposed inside the second nozzle. The first portion and second portion of the motive fluid generate vacuum that draws the entrained fluid through the first port into the mixing chamber.

According to a third aspect of this disclosure, an apparatus is disclosed that comprises an ejector housing defining a suction chamber, a mixing chamber, and a diffuser nozzle that defines a restrictive orifice, and a diffuser outlet. A first port supplies an entrained fluid to the mixing chamber. A first motive fluid nozzle includes a first valve for selectively suppling a first portion of the motive fluid to the mixing chamber through a first motive fluid nozzle outlet that extends into the mixing chamber. A second motive fluid nozzle includes a second valve for selectively suppling a second portion of the motive fluid to the mixing chamber through a second motive fluid nozzle outlet that extends into the mixing chamber. A controller selectively opens and closes the first valve and the second valve, wherein the first valve is closed when the second valve is opened to provide a first level of fluid flow through the first port, wherein the second valve is closed when the first valve is opened to provide a second level of fluid flow through the first port, and wherein when both the first valve and the second valve are opened, a third level of fluid flow through the first port is provided.

This disclosure also comprises the following alternatives, variations, and optional features of the three above aspects of this disclosure:
the first motive fluid nozzle is larger than the second motive fluid nozzle, and wherein the second motive fluid nozzle is disposed inside the second nozzle.
the first motive fluid nozzle outlet is circular, and the second motive fluid nozzle is circular.
the second motive fluid nozzle outlet is concentric relative to the first motive fluid nozzle.
the entrained fluid supplied by the first port is nitrogen.
the motive fluid is hydrogen.
the first motive fluid nozzle is closed when the second motive fluid nozzle is open to provide a selected level of entrained fluid flow through the first port.
the second motive fluid nozzle is closed when the first motive fluid nozzle is open to provide a selected level of entrained fluid flow through the first port.
the first motive fluid nozzle is closed when the second motive fluid nozzle is open to provide a first level of entrained fluid flow, wherein the second motive fluid nozzle is closed when the first motive fluid nozzle is open to provide a second level of entrained fluid flow, and wherein when both the first motive fluid nozzle are open, and the second motive fluid nozzle is open a third level of entrained fluid flow is provided.
the first level of entrained fluid flow through the first port is less than the second level of entrained fluid flow, and the second level of entrained fluid flow through the first port is less than the third level of entrained fluid flow through the first port.

The above aspects of this disclosure and other aspects will be described below with reference to the attached drawings.

### BRIEF DESCRIPTION OF THE DRAWINGS

FIG. 1 is a diagrammatic cross section view showing the fuel cell ejector of this disclosure.

FIG. 2 is a diagrammatic cross section view showing the fuel cell ejector of FIG. 1 with arrows illustrating potential gas flows.

FIG. 3A is diagrammatic cross section view showing the fuel cell ejector of FIG. 1 with arrows illustrating gas flow with first motive gas nozzle open and the second motive gas nozzle closed.

FIG. 3B is a diagrammatic cross section view showing the fuel cell ejector of FIG. 1 with arrows illustrating gas flow with the first motive gas inlet closed and the second motive gas inlet open.

FIG. 3C is a diagrammatic cross section view showing the fuel cell ejector of FIG. 1 with arrows illustrating gas flow with the first motive gas inlet open and the second motive gas inlet open.

FIG. 4A is a chart showing the expected hydrogen gas flow with a prior design on the left and showing the expected hydrogen gas flow with the design of this disclosure on the right when the first motive gas nozzle is open, and the second motive gas nozzle is closed.

FIG. 4B is a chart showing the expected hydrogen gas flow with a prior design on the left and showing the expected hydrogen gas flow with the design of this disclosure on the right when the first motive gas nozzle is closed, and the second motive gas nozzle is open.

FIG. 4C is a chart showing the expected hydrogen gas flow with a prior design on the left and showing the expected hydrogen gas flow with the design of this disclosure on the right when the first motive gas nozzle is open, and the second motive gas nozzle is open.

FIG. 5 is a diagrammatic cross section view showing an alternative embodiment of the fuel cell ejector of this disclosure.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale, and some features may be exaggerated or minimized to show details of particular components. The specific structural and functional details disclosed are not to be interpreted as limiting, but as a representative basis for teaching one skilled in the art how to practice the disclosed concepts.

Various features illustrated and described with reference to any one of the figures may be combined with features illustrated in one or more of the other figures to produce embodiments that are not explicitly illustrated or described. The combinations of features illustrated provide representative embodiments for typical applications. Various combinations and modifications of the features consistent with the teachings of this disclosure could be used in particular applications or implementations.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.”

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

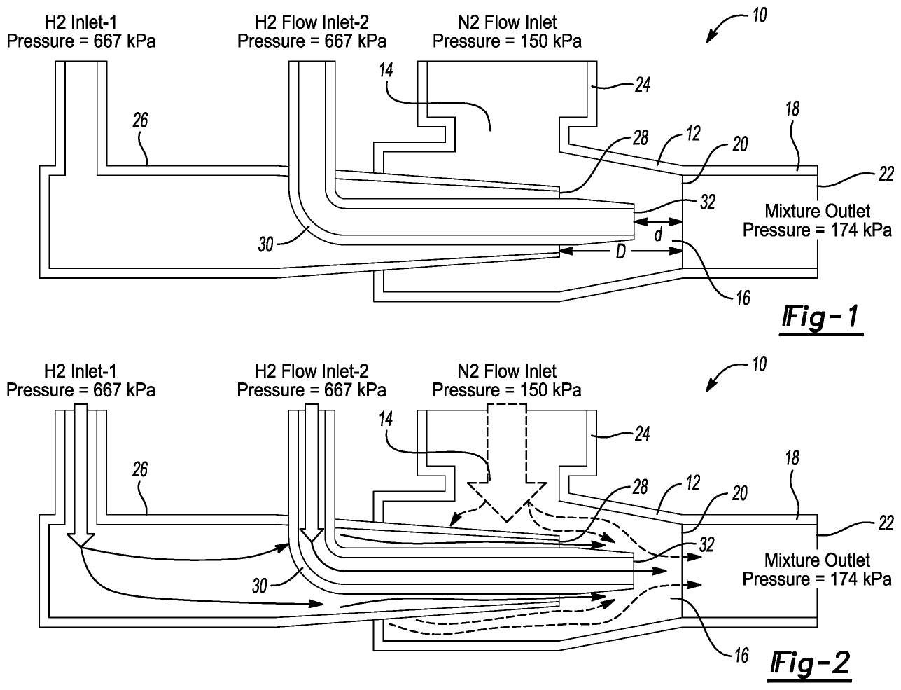

Referring to FIG. 1, an ejector 10 for a fuel cell (not shown) is illustrated diagrammatically. The ejector 10 includes an ejector housing 12. The ejector housing 12 defines a suction chamber 14, a mixing chamber 16, and a diffuser nozzle 18 that defines a restrictive orifice 20, and a diffuser outlet 22.

The ejector housing 12 includes an inlet port 24 through which an entrained fluid (e. g. nitrogen) is drawn into the suction chamber 14. In one example, nitrogen is supplied at a pressure of 150 kPa.

A first motive fluid nozzle 26 is assembled to the ejector housing 12 in axial alignment with the diffuser nozzle 18. The restrictive orifice 20 of the diffuser nozzle 18 is provided down stream from the mixing chamber 16. The first motive fluid nozzle 26 extends into the mixing chamber 16 to a distance “D” from the restrictive orifice 20. The first motive fluid nozzle has a first circular tip 28.

A second motive fluid nozzle 30 is assembled to the ejector housing 12 in axial alignment with the diffuser nozzle 18. The restrictive orifice 20 of the diffuser nozzle 18 is provided downstream from the mixing chamber 16. The second motive fluid nozzle 30 extends into the mixing chamber 16 to a distance “d” from the restrictive orifice 20. The distance “D” is larger than the distance “d” The first motive fluid nozzle has a first circular tip 28. The second motive fluid nozzle 30 has a second circular tip 32.

In the illustrated embodiment, the second motive fluid nozzle 30 is disposed in a concentric relationship within the first motive fluid nozzle 26. This is one example of an arrangement of the two nozzles 26 and 30 but other arrangements are possible and are within the scope of this disclosure and the appended claims.

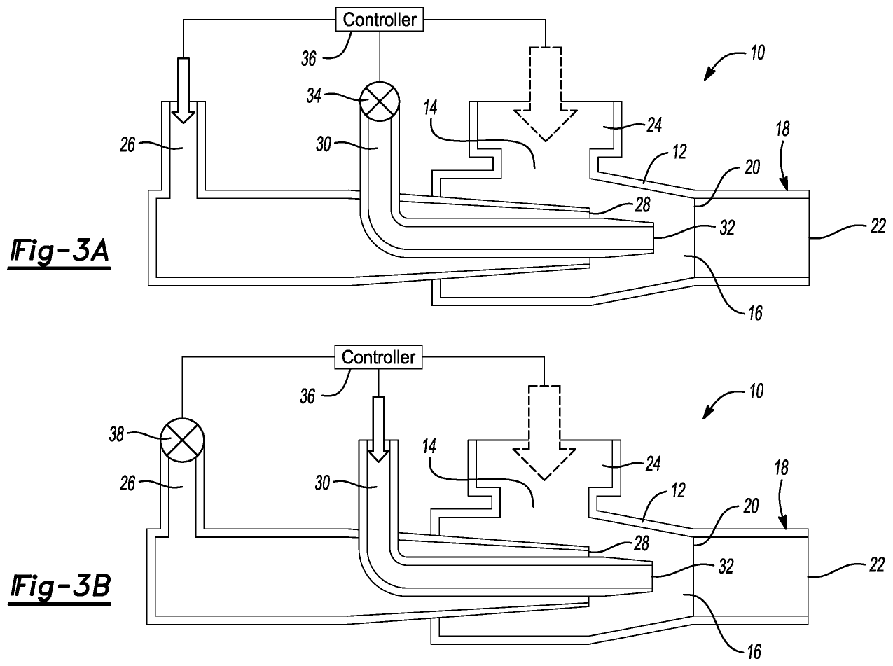

Referring to FIG. 2, the flow of the motive fluid and the secondary fluid flow through the port 24 is illustrated with solid line arrows depicting the motive fluid flow and the dashed line arrows depicting the flow of the secondary fluid through the port 24.

The motive fluid is hydrogen (H₂) that is supplied to the first motive fluid nozzle 26 and the second motive fluid nozzle 30. In the illustrated embodiment, the hydrogen is supplied at a pressure of 667 kPa through both nozzles 26 and 30. The entrained fluid supplied through the inlet port 24 is nitrogen (N₂) that is supplied at a pressure of 150 kPa. The motive fluid and entrained fluid mix in the mixing chamber 16 and flow together to the diffuser nozzle 18 and are ejected together through the restrictive orifice 20 and the diffuser outlet at a pressure of 174 kPa. Other gases and gaseous mixtures may be substituted for hydrogen and nitrogen. The specific pressures disclosed with reference to FIG. 2 are merely examples and can be changed substantially depending on the result desired.

The second motive fluid nozzle 30 is inside the first motive fluid nozzle 26 and extends further downstream of the mixing section 16 within the main converge cone. The first motive fuel nozzle 26 flows through the annulus defined between the first circular tip 28 and the second circular tip 32 and exits on the upstream side of the first motive fluid nozzle 26 and generates vacuum that sucks the entrained fluid N₂ flow into the mixing section. The motive H₂ gas from inlet-2 flows through the inner nozzle and exits at downstream side of the main converge cone and generate further deeper vacuum to suck more N₂ into the mixing section.

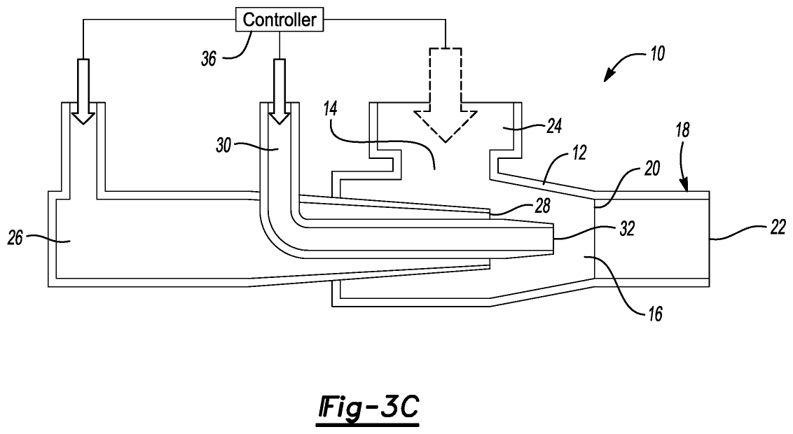

Referring to FIG. 3A, the ejector 10 is shown with a first valve 34 (depicted diagrammatically) closing off the second motive fluid nozzle 30. A controller 36 actuates the first valve 34 depending upon the desired level of entrained fluid flow. The first motive fluid nozzle 26 is open and the motive fluid flows into the mixing chamber 16 creating a vacuum that draws the entrained fluid through the first port 24 at a first flow rate.

Referring to FIG. 3B, the ejector 10 is shown with the second valve 38 (depicted diagrammatically) closing off the first motive fluid nozzle 26. The controller 36 actuates the second valve 38 depending upon the desired level of entrained fluid flow. The second motive fluid nozzle 30 is open and the motive fluid flows into the mixing chamber 16 creating a vacuum that draws the entrained fluid through the first port 24 at a second flow rate that is greater than the first flow rate.

Referring to FIG. 3C, the ejector 10 is shown with the first valve 34 and the second valve 38 open to provide fluid flow through both the first motive fluid nozzle and the second motive fluid nozzle 30, respectively. The first valve 34 and the second valve 38 are both open and the motive fluid flows into the mixing chamber 16 creating a greater level of vacuum that draws the entrained fluid through the first port 24 at a third flow rate that is greater than the second flow rate.

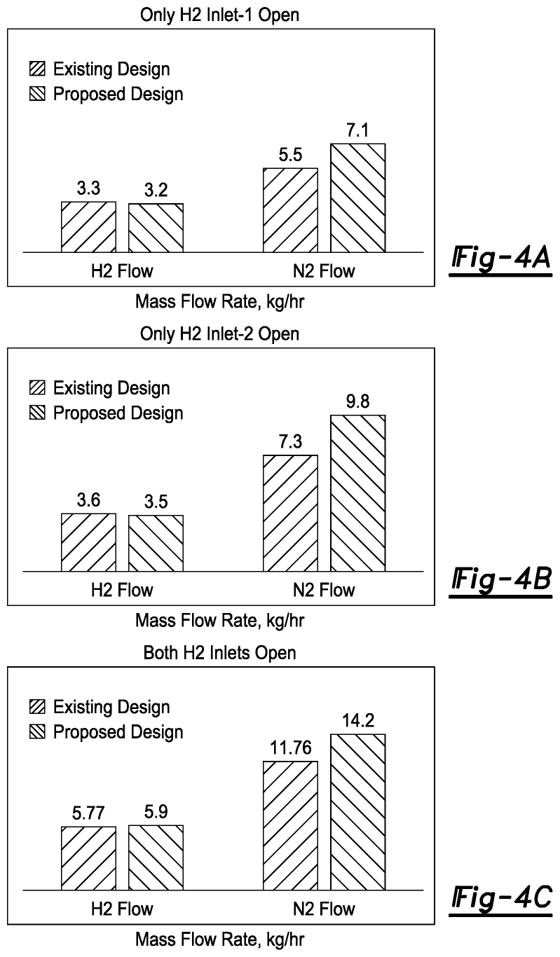

Referring to FIG. 4A, the operating condition shown in FIG. 3A is compared to an existing ejector design with the mass flow rate measured in units of kg/hour. The embodiment of FIG. 3A is the lowest nitrogen (N2) flow condition. The existing design provided a flow of hydrogen of 3.3 kg/hour that provided nitrogen flow of 5.5 kg/hour. In comparison, the disclosed design (“proposed design” in FIG. 4A-4C) provided a flow of hydrogen of 3.2 kg/hour that provided nitrogen flow of 7.1 kg/hour.

Referring to FIG. 4B, the operating condition shown in FIG. 4B is compared to the existing ejector design. The embodiment of FIG. 3B is the intermediate nitrogen flow condition and provided a flow of hydrogen of 3.6 kg/hour that provided nitrogen flow of 7.3 kg/hour. In comparison to the existing design, the disclosed design (“proposed design” in FIG. 4B) provided a flow of hydrogen of 3.5 kg/hour that provided nitrogen flow of 9.8 kg/hour.

Referring to FIG. 4C, the operating condition shown in FIG. 4C is compared to the existing ejector design. The embodiment of FIG. 3C is the maximum nitrogen flow condition and provided a flow of hydrogen of 5.77 kg/hour that provided nitrogen flow of 11.6 kg/hour. In comparison to the existing design, the disclosed design (“proposed design” in FIG. 4C) provided a flow of hydrogen of 5.9 that provided nitrogen flow of 14.2 kg/hour.

The disclosed ejector 10 provides one of three levels of entrained fluid nitrogen flow with the controller 36 actuating the first valve 34 and the second valve 38.

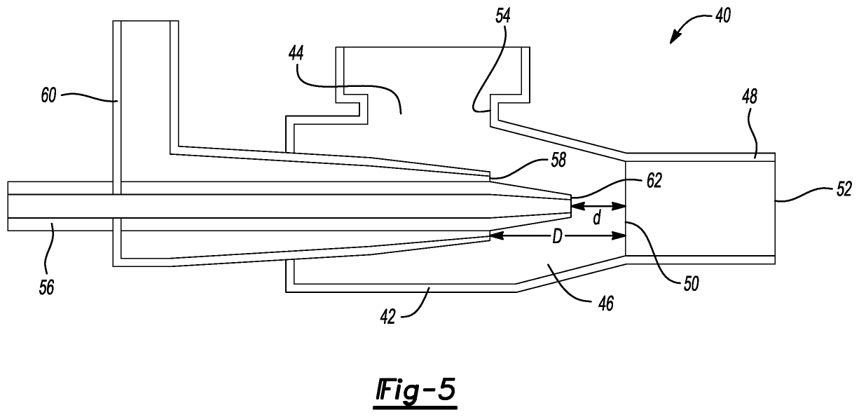

Referring to FIG. 5, an alternative embodiment of an ejector 40 for a fuel cell is illustrated diagrammatically. The ejector 40 includes an ejector housing 42. The ejector housing 42 defines a suction chamber 44, a mixing chamber 46, and a diffuser nozzle 48 that defines a restrictive orifice 50, and a diffuser outlet 52.

The ejector housing 42 includes an inlet port 54 through which an entrained fluid is drawn into the suction chamber 44.

A first motive fluid nozzle 56 is assembled to the ejector housing 42 in axial alignment with the diffuser nozzle 48. In the alternative embodiment, the entire length of the first motive fluid flow nozzle 56 is axially aligned with the diffuser nozzle 48. The restrictive orifice 50 of the diffuser nozzle 48 is provided downstream from the mixing chamber 46. The first motive fluid nozzle 56 extends into the mixing chamber 46 to a distance “D” from the restrictive orifice 50. The first motive fluid nozzle has a first circular tip 58.

A second motive fluid nozzle 60 is assembled to the ejector housing 42 in axial alignment with the diffuser nozzle 48. The restrictive orifice 50 of the diffuser nozzle 48 is provided downstream from the mixing chamber 46. The second motive fluid nozzle 60 extends into the mixing chamber 46 to a distance “d” from the restrictive orifice 50. The distance “D” is larger than the distance “d” The first motive fluid nozzle has a first circular tip 58. The second motive fluid nozzle 60 has a second circular tip 62.

In one example, nitrogen is supplied through the inlet port 54 at a pressure of 150 kPa. Hydrogen is supplied through the first and second motive fluid ports 56 and 60 at a pressure of 667 kPa. This results in a pressure of the mixture of hydrogen and nitrogen of 174 kPa at the diffuser outlet 52.

In the illustrated embodiment, the second motive fluid nozzle 60 is disposed in a concentric relationship within the first motive fluid nozzle 56. This is one example of an arrangement of the two nozzles 56 and 60 but other arrangements are possible and are within the scope of this disclosure and the appended claims.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and includes modifications of the illustrated embodiments. In addition, the features of various implementing embodiments may be combined to form further embodiments of the invention.

What is claimed is:

1. An apparatus comprising:
an ejector housing defining a suction chamber, a mixing chamber, and a diffuser nozzle that defines a restrictive orifice, and a diffuser outlet;
a first port supplies an entrained fluid to the mixing chamber;
a first motive fluid nozzle supplies a first portion of a motive fluid to the mixing chamber through a first motive fluid nozzle outlet that extends into the mixing chamber to a first location spaced a distance “D” from the restrictive orifice; and
a second motive fluid nozzle supplies a second portion of a motive fluid to the mixing chamber through a second motive fluid nozzle outlet that extends into the mixing chamber to a second location spaced a distance “d” from the restrictive orifice, wherein the distance d is less than the distance “D,” and wherein the first portion and second portion of the motive fluid generate vacuum that draws the fluid flowing through the first port into the mixing chamber.

2. The apparatus of claim 1 wherein the first motive fluid nozzle is larger than the second motive fluid nozzle, and wherein the second motive fluid nozzle is disposed inside the second motive fluid nozzle.

3. The apparatus of claim 2 wherein the first motive fluid nozzle outlet is circular, and the second motive fluid nozzle is circular.

4. The apparatus of claim 3 wherein the second motive fluid nozzle outlet is concentric relative to the first motive fluid nozzle.

5. The apparatus of claim 1 wherein the entrained fluid supplied by the first port is nitrogen.

6. The apparatus of claim 1 wherein the first portion and the second portion of the motive fluid is hydrogen.

7. The apparatus of claim 1 wherein the first motive fluid nozzle is closed when the second motive fluid nozzle is open to provide a selected level of entrained fluid flow through the first port.

8. The apparatus of claim 1 wherein the second motive fluid nozzle is closed when the first motive fluid nozzle is open to provide a selected level of entrained fluid flow through the first port.

9. The apparatus of claim 1 wherein the first motive fluid nozzle is closed when the second motive fluid nozzle is open to provide a first level of entrained fluid flow, wherein the second motive fluid nozzle is closed when the first motive fluid nozzle is open to provide a second level of entrained fluid flow, and wherein when both the first motive fluid nozzle are open, and the second motive fluid nozzle is open a third level of entrained fluid flow is provided.

10. The apparatus of claim 9 wherein the first level of entrained fluid flow through the first port is less than the second level of entrained fluid flow, and the second level of entrained fluid flow through the first port is less than the third level of entrained fluid flow through the first port.

11. An apparatus comprising:
an ejector housing defining a suction chamber, a mixing chamber, and a diffuser nozzle that defines a restrictive orifice, and a diffuser outlet;
a first port supplies an entrained fluid to the mixing chamber;
a first motive fluid nozzle supplies a first portion of the motive fluid to the mixing chamber through a first motive fluid nozzle outlet that extends into the mixing chamber; and
a second motive fluid nozzle supplies a second portion of the motive fluid to the mixing chamber through a second motive fluid nozzle outlet that extends into the mixing chamber, wherein the first motive fluid nozzle is larger than the second motive fluid nozzle, and wherein the second motive fluid nozzle is disposed inside the second motive fluid nozzle, and wherein the first portion and second portion of the motive fluid generate vacuum that draws the entrained fluid flowing through the first port into the mixing chamber.

12. The apparatus of claim 11 wherein the first motive fluid nozzle outlet is circular, and the second motive fluid nozzle is circular.

13. The apparatus of claim 12 wherein the second motive fluid nozzle outlet is concentric relative to the first motive fluid nozzle.

14. The apparatus of claim 11 wherein the first motive fluid nozzle extends into the mixing chamber to a first location spaced a distance “D” from the restrictive orifice; and the second motive fluid nozzle extends into the mixing chamber to a second location spaced a distance “d” from the restrictive orifice, wherein the distance “d” is less than the distance “D.”

15. An apparatus comprising:
an ejector housing defining a suction chamber, a mixing chamber, and a diffuser nozzle that defines a restrictive orifice, and a diffuser outlet;
a first port supplies an entrained fluid to the mixing chamber;
a first motive fluid nozzle includes a first valve for selectively suppling a first portion of the motive fluid to the mixing chamber through a first motive fluid nozzle outlet that extends into the mixing chamber;
a second motive fluid nozzle includes a second valve for selectively suppling a second portion of the motive fluid to the mixing chamber through a second motive fluid nozzle outlet that extends into the mixing chamber; and
a controller selectively opens and closes the first valve and the second valve, wherein the first valve is closed when the second valve is opened to provide a first level of entrained fluid flow through the first port, wherein the second valve is closed when the first valve is opened to provide a second level of entrained fluid flow through the first port, and wherein when both the first valve and the second valve are opened, a third level of entrained fluid flow through the first port is provided.

16. The apparatus of claim 15 wherein the first motive fluid nozzle extends into the mixing chamber to a first location spaced a distance “D” from the restrictive orifice; and the second motive fluid nozzle extends into the mixing chamber to a second location spaced a distance “d” from the restrictive orifice, wherein the distance “d” is less than the distance “D.”

17. The apparatus of claim 15 wherein the first motive fluid nozzle outlet is circular, and the second motive fluid nozzle is circular.

18. The apparatus of claim 15 wherein the second motive fluid nozzle outlet is concentric relative to the first motive fluid nozzle.

19. The apparatus of claim 15 wherein the entrained fluid supplied by the first port is nitrogen.

20. The apparatus of claim 15 wherein the first portion of motive fluid and the second portion of the motive fluid are hydrogen.
